(19) United States
(12) Patent Application Publication
(10) Pub. No.: US 2010/0293876 A1
(43) Pub. Date: Nov. 25, 2010

(54) Multi-Dimensional Door Frame

(76) Inventor: Jose Genaro Contreras de la Pena, Michoacan (MX)

Correspondence Address: INTELLECTUAL PROPERTY / TECHNOLOGY LAW, PO BOX 14329, RESEARCH TRIANGLE PARK, NC, 27709, US

(21) Appl. No.: 12/670,346

(22) PCT Filed: Jul. 23, 2008
(86) PCT No.: PCT/MX2008/000096

§ 371 Date: Aug. 3, 2010

(30) Foreign Application Priority Data
Jul. 25, 2007 (MX) MX/U/2007/000241

(51) Int. Cl. E06B 1/52

(52) U.S. Cl. 52/217

(57) ABSTRACT

This invention provides a type of door frame totally different from those in current use and characterized in the novel design and construction thereof by having an interior space for redimensioning it to any measurement within the range for cutting between the vertical inner jamb and the vertical outer moving jamb, by making a single cut and reassembling the outer moving jamb in order to obtain a new measurement for the door.

### OBJECT OF THE INVENTION

This invention concerns a multi-dimensional frame, specifically in order to be able to resize the door according to the need for specific measurements in hollow doors and/or other products that are built using the same principles as this type of frame.

### BACKGROUND OF THE INVENTION

Currently the frames used in the manufacture of hollow doors are principally built of wood. These doors are of fixed preset measurements. Their construction and structure do not allow resizing, so the door frame itself offers a door that may be adjusted to a specific measurement.

This limiting factor in the existing door frames forces distributors to maintain a broad and varied inventory in order to cover the needs for the measurements that the market requires and in some cases cannot cover specific measurements, besides not being able to provide the security of equal movement in sales of each of the different door measurements, which may produce an inventory with little or no turnover and over time the door may suffer physical deterioration which will require that the door be: auctioned, returned to the manufacturer, or become a total loss, causing great losses for the distributor in the first case and in the second for the manufacturer.

For the purpose of eliminating these and other disadvantages, this multi-dimensional frame was thought of for development, the protection of which is sought via this application. The characteristics of this invention have been designed to resolve this problem or limiting factor in frames used for the manufacture of doors existing on the market.

For this reason, its characteristics focus on the fact that the same frame may be sized to any measurement desired within the resizing range to achieve a single door. [SIC] This allows both the distributor as well as the manufacturer to not have dead or slow inventory and with a smaller inventory they can cover all the needs of the market, for example; a distributor purchases 100 conventional doors, divided in groups in the measurements required by the market (20 of one measurement, 10 of another measurement, 15 of another measurement, etc.), but with this door frame system he would have 100 doors of each measurement, since each one of these multi-dimensional doors will adapt to any measurement the client wants with one simple cut.

### BRIEF DESCRIPTION OF THE FIGURES

FIG. 1.—Shows a front, side, and top view of the multi-dimensional frame.

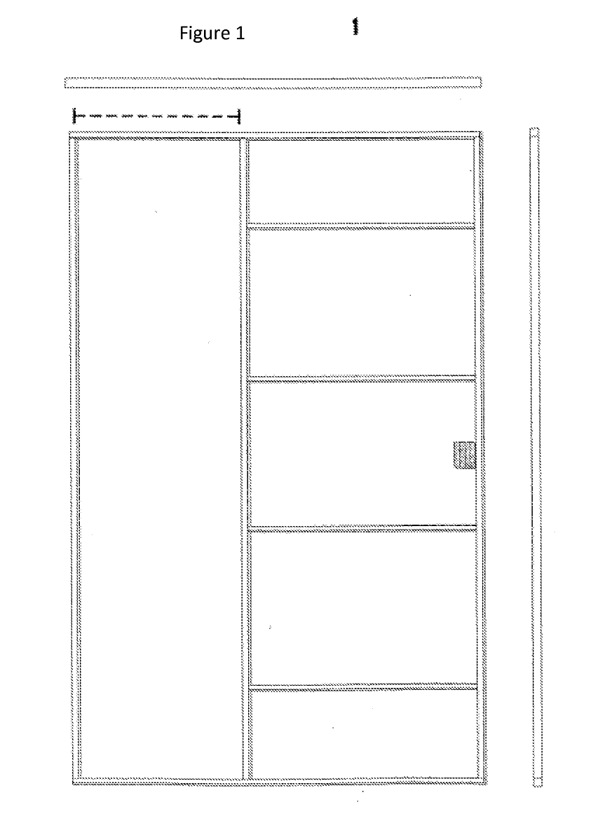

FIG. 2.—Shows an exploded front view showing the components of the multi-dimensional frame.

FIG. 3.—Front and side view of the placement and assembly of the mobil post.

FIG. 4.—View of the parts and sections of the multi-dimensional frame assembly.

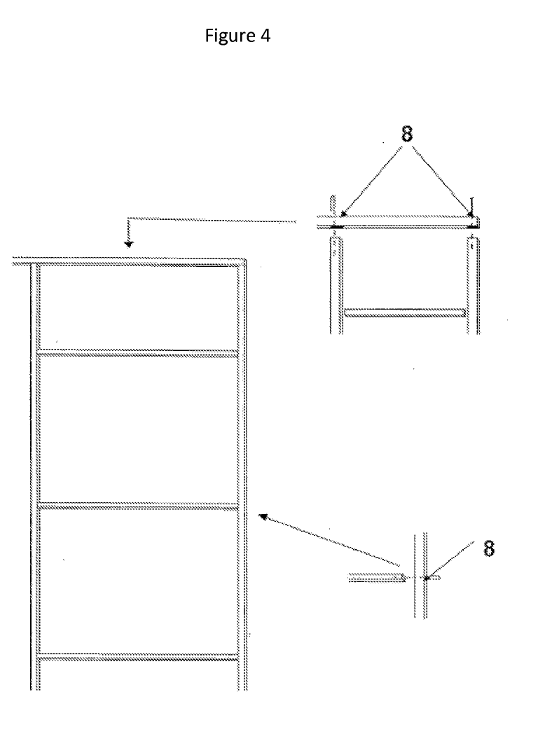

FIG. 5.—View of the placement for the lock.

### DESCRIPTION

To complete the description given here and for the purpose of helping to provide better understanding of the characteristics of the invention and its variations, I have accompanied the following description with drawings (for the purpose of illustration and not of a restrictive nature) as an integral part of this description, showing its structure, method of assembly, and components.

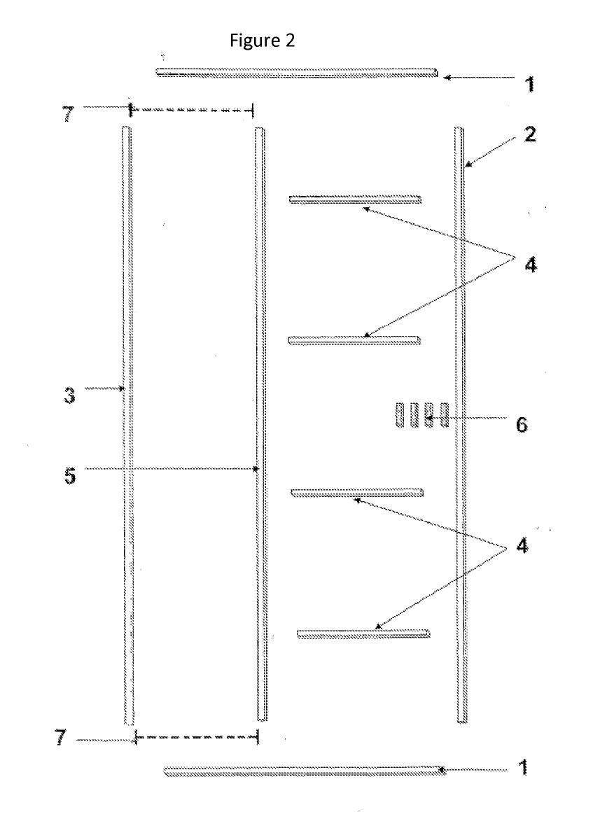

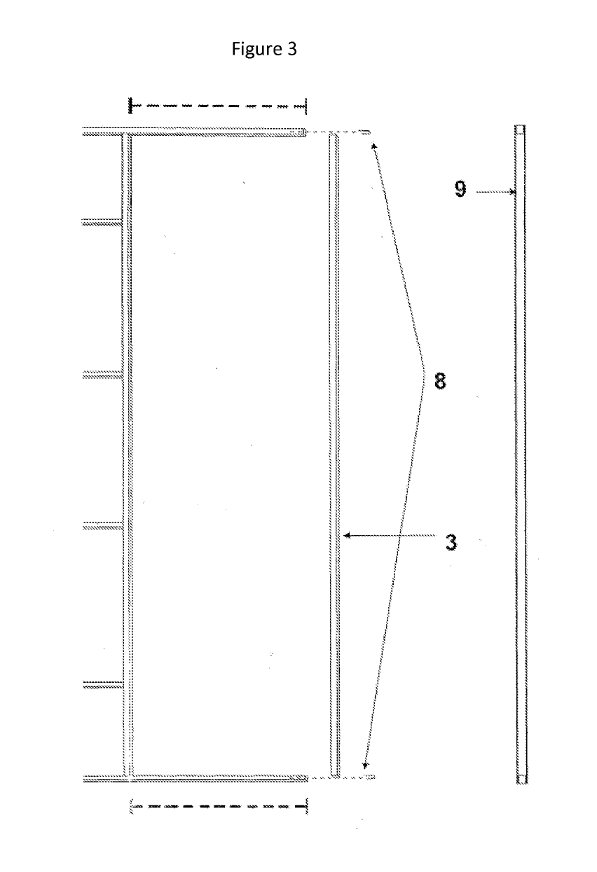

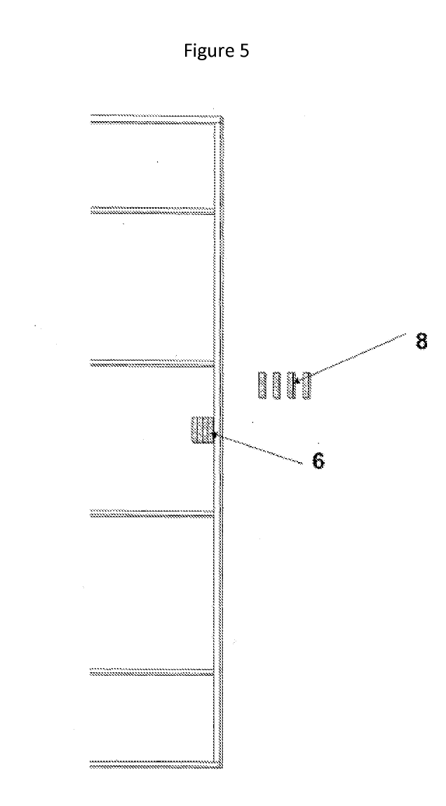

The structure of this MULTI-DIMENSIONAL frame is comprised by 4 square exterior posts; two crossbeams (1) and two jambs, one fixed and the other one mobile (2/3) (FIG. 2) chiefly made of wood. On the inside it contains an interior central jamb (5) (FIG. 2), with several crossbeams (4) (FIG. 2) between the center fixed jamb and the exterior fixed jamb to give structure and rigidity to the door. A section chiefly made of wood is also placed on the side of the horizontal crossbeams in order to provide an area for placement of the lock (6) placement and location in the frame [SIC] (FIGS. 2 and 5), which will be covered with triply plywood and/or any other laminated material or with die cast covers attached to the frame using an adhesive and/or a chemical substance, nails, or staples (8). With all components of the frame, (except the mobile jamb) being attached with a nail and/or staple as well as by an adhesive or chemical substance (8), the exterior mobile jamb (3) is simply attached to the exterior crossbeams with a removable staple (FIG. 3), with this jamb being removed when resizing is needed in order to be used and is not discarded when the cut is made,

with the main and innovative characteristic of the multi-dimensional frame being the existence of an interior space that offers a resizing range to any measurement from the center interior jamb to the mobile jamb (FIGS. 2 and 3), once the door is resized to the size desired the mobile jamb is attached to the ends of the exterior crossbeams and the frame cover using nails and/or staples in addition to adhesive and/or chemical substances, which is the exact space for the placement of the jamb (FIG. 3, No. 9) and thus obtains a door of the exact measurement desired.

All the jambs, crossbeams, and components of the frame may be of the width, size, amount, and proportions needed to make its structure, measurements, and quality exactly right to provide an optimal performance, both in the cost and the functionality that each market demands. In some cases the wood used in manufacturing the door is substituted by more economical materials in order to reduce cost.

It was reported that results obtained from various factory performed tests on the structure, assembly, and operation were totally satisfactory.

1-6. (canceled)

7. A multi-dimensional door frame comprising:
a) a top and bottom horizontal crossbeams, each comprising left and right ends,
b) a fixed exterior vertical jamb, comprising a top and a bottom end,
c) a mobile jamb comprising a top and bottom end,
d) a central jamb placed parallel to and between the fixed and mobile jambs, said central jamb comprising a top and bottom end,
wherein:
i) the top end of the fixed exterior vertical jamb is attached to the right end of the top horizontal crossbeam,
ii) the bottom end of the fixed exterior vertical jamb is attached to the right end of the bottom horizontal crossbeam,
iii) the top end of the mobile jamb is removably attached to the left end of the top horizontal crossbeam,
iv) the bottom end of the mobile jamb is removably attached to the right end of the bottom horizontal crossbeam,
v) the top end of the central jamb is attached to the top horizontal crossbeam at a position between the left and right ends of the top horizontal crossbeam,
vi) the bottom end of the central jamb is attached to the bottom horizontal crossbeam at a position between the left and right ends of the bottom horizontal crossbeam, such that the central jamb is parallel to the fixed exterior vertical jamb,
e) a plurality of horizontal crossbeams connecting the fixed exterior vertical jamb to the central jamb, and
f) an assembly of wood adjacent to the fixed exterior vertical jamb sufficient to receive a door lock,
wherein the frame is sized in such a way that a resizing space exists between the mobile jamb and the central jamb, such that the door can be resized by removing the movable jamb from the top and bottom horizontal crossbeams, cutting and resizing the crossbeams, and reattaching the movable jamb.

8. The door frame of claim 7, further comprising a covering selected from the group consisting of plywood and die cast covers.

9. The door frame of claim 8, wherein the frame covers are attached using adhesives, chemical substances, nails, or staples.

10. The door frame of claim 7, wherein the jambs and crossbeams are attached to each other using nails, staples, adhesives, or chemical substances.

11. The door frame of claim 10, wherein the mobile jamb is attached to the horizontal crossbeams with removable staples.

12. The door frame of claim 7, wherein the individual frame components of the frame are selected from the group consisting of wood, plywood, composite materials, and plastic.

13. The door frame of claim 7, wherein there are at least four horizontal crossbeams connecting the fixed exterior vertical jamb to the central jamb.

14. A method of resizing a door frame, comprising:
a) providing a multi-dimensional door frame of claim 7,
b) removing the removable attachments between the movable jamb and the top and bottom horizontal crossbeams,
c) cutting the top and bottom horizontal crossbeams to a predetermined width of the door frame, and
d) reattaching the movable jamb to the top and bottom horizontal crossbeams.

15. The method of claim 14, further comprising attaching a covering selected from the group consisting of plywood and die cast covers.

16. The method of claim 15, wherein the frame covers are attached using adhesives, chemical substances, nails, or staples.

17. The method of claim 14, wherein the jambs and crossbeams are attached to each other using nails, staples, adhesives, or chemical substances.

18. The method of claim 17, wherein the mobile jamb is attached to the horizontal crossbeams with removable staples.

19. The method of claim 14, wherein the individual frame components of the frame are selected from the group consisting of wood, plywood, composite materials, and plastic.

20. The method of claim 14, wherein there are at least four horizontal crossbeams connecting the fixed exterior vertical jamb to the central jamb.
